(19) United States
(12) Patent Application Publication
(10) Pub. No.: US 2015/0351479 A1
(43) Pub. Date: Dec. 10, 2015

(54) SYSTEM FOR DISPLAYING A GRAPHIC ON A HELMET

(71) Applicant: Andrew Cali, Huntington Station, NY (US)

(72) Inventor: Andrew Cali, Huntington Station, NY (US)

(21) Appl. No.: 14/295,517

(22) Filed: Jun. 4, 2014

(51) Int. Cl. A42B 3/04; G09F 3/16; G09F 3/14; A42B 3/18; G09F 3/08

(52) U.S. Cl. CPC A42B 3/0433; A42B 3/18; G09F 3/08; G09F 3/14; G09F 3/16

(57) ABSTRACT

A system for displaying one or more graphics on a sports helmet, including a strap material of a length which is sufficient to wrap completely around a selected portion of a helmet, with the strap material being flexible and substantially planar. One or more fasteners are included on opposing ends of the strap material, and a loop with one or more substantially flat surfaces is formed by connecting the fasteners to the fasteners included on the opposing end of the strap material. A section of the one or more substantially flat surfaces of the strap material display one or more graphics, and the graphics are positioned outwardly such that the graphics are visible when the material is wrapped around the selected portion of the helmet.

### BACKGROUND

1. Technical Field

The present invention relates to a system for displaying a graphic on a helmet, and more particularly to a system for displaying graphics on a helmet using a strap which attaches to a facemask on a helmet.

2. Description of the Related Art

Systems currently exist for advertising on a helmet by completely covering a helmet with a decorative material, but there exists a need for, and there is currently no system or method which employs a strap which includes graphics (e.g., advertising materials, names, logos, etc.) which attaches to a facemask on a helmet.

### SUMMARY

A system for displaying one or more graphics on a sports helmet, comprising a strap material of a length which is sufficient to wrap completely around a selected portion of a helmet, wherein the strap material is flexible and substantially planar. One or more fasteners are included on opposing ends of the strap material, wherein a loop with one or more substantially flat surfaces is formed by connecting the one or more fasteners to the one or more fasteners attached to the opposing end of the strap material. A section of the one or more substantially flat surfaces of the strap material displays the one or more graphics, wherein the one or more graphics are positioned outwardly such that the one or more graphics are visible when the strap material is wrapped around the selected portion of the helmet.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing a system for advertising on a helmet using a strap in accordance with an illustrative embodiment;

FIG. 2 is a diagram showing a system for advertising on a helmet using a strap with button fasteners in accordance with an illustrative embodiment;

FIG. 3 is a diagram showing a system for advertising on a helmet using a strap with a fabric hook and loop fastener (e.g., Velcro®) in accordance with an illustrative embodiment;

FIG. 4 is a diagram showing a system for advertising on a helmet using a strap with magnetic fasteners in accordance with an illustrative embodiment;

FIG. 5 is a diagram showing a system for advertising on a helmet using a strap in accordance with an illustrative embodiment;

FIG. 6 is a diagram showing a system for advertising on a helmet using a strap which includes a clip for holding a mouthpiece.

FIG. 7 is a diagram showing a system for advertising on a helmet using a sticker-type device in accordance with an illustrative embodiment; and

FIG. 8 is a diagram showing a system for advertising on a helmet using a clip in accordance with an illustrative embodiment.

### DETAILED DESCRIPTION OF PREFERRED EMBODIMENTS

Manufacturers and retailers often promote their products with attention-grabbing advertisements, names, logos, etc. The present principles may employ a strap with advertising, names, logos, etc. thereon which may attach to a helmet by wrapping around one or more portions of the helmet to display advertisements, names, logos, etc. The strap may include printed graphics, a Light Emitting Diode (LED) screen, a video screen, or any suitable method of displaying graphics. The strap may also include a clip for attaching a mouthpiece to the strap in accordance with illustrative embodiments.

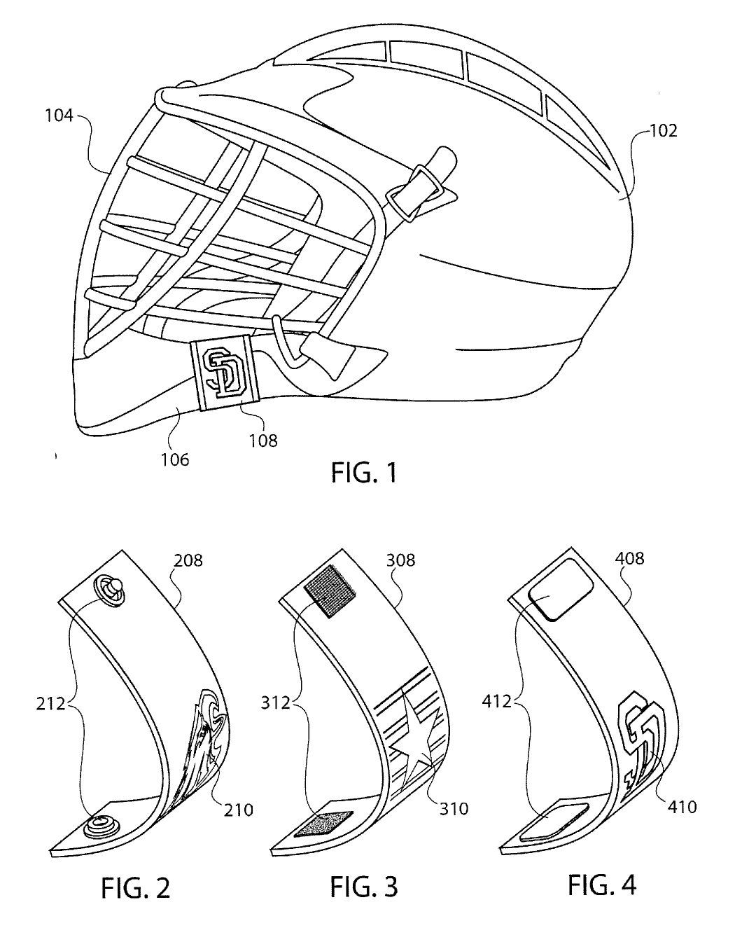

Referring now to the drawings in which like numerals represent the same or similar elements and initially to FIG. 1, a diagram of a system for advertising on a helmet using a strap is illustratively depicted in accordance with the present principles. In one embodiment, a sports helmet (e.g., Lacrosse, Football, Hockey, etc.) includes a shell 102, a facemask 104, and a chin bar 108. A strap 108 including advertisements, names, logos, etc. may be attached to the chin bar 106 by wrapping the strap 108 around the chin bar 106 such that a substantially flat surface including the advertisements, names, logos, etc. on the strap 108 faces outwardly such that the advertisements, names, logos, etc. are visible on the substantially flat surface of the strap 108.

Referring now to FIG. 2, a diagram showing a system for advertising on a helmet using a strap with one or more button/snap fasteners is illustratively depicted in accordance with one embodiment of the present principles. In an illustrative embodiment, a strap 208 including advertisements, logos, etc. 210 may include one or more button/snap fasteners 212 in accordance with the present principles. The fasteners 212 may be employed to secure the strap around a portion of a helmet (not shown) such that the advertisements, names, logos, etc. 210 are visible on the substantially flat outward-facing surface of the strap 208.

Referring now to FIG. 3, a diagram showing a system for advertising on a helmet using a strap with one or more fabric hook and loop fasteners (e.g., Velcro®) is illustratively depicted in accordance with one embodiment of the present principles. In an illustrative embodiment, a strap 308 including advertisements, logos, etc. 310 may include one or more fabric hook and loop fasteners 312 in accordance with the present principles. The fasteners 312 may be employed to secure the strap around a portion of a helmet (not shown) such that the advertisements, names, logos, etc. 310 are visible on the substantially flat outward-facing surface of the strap 308.

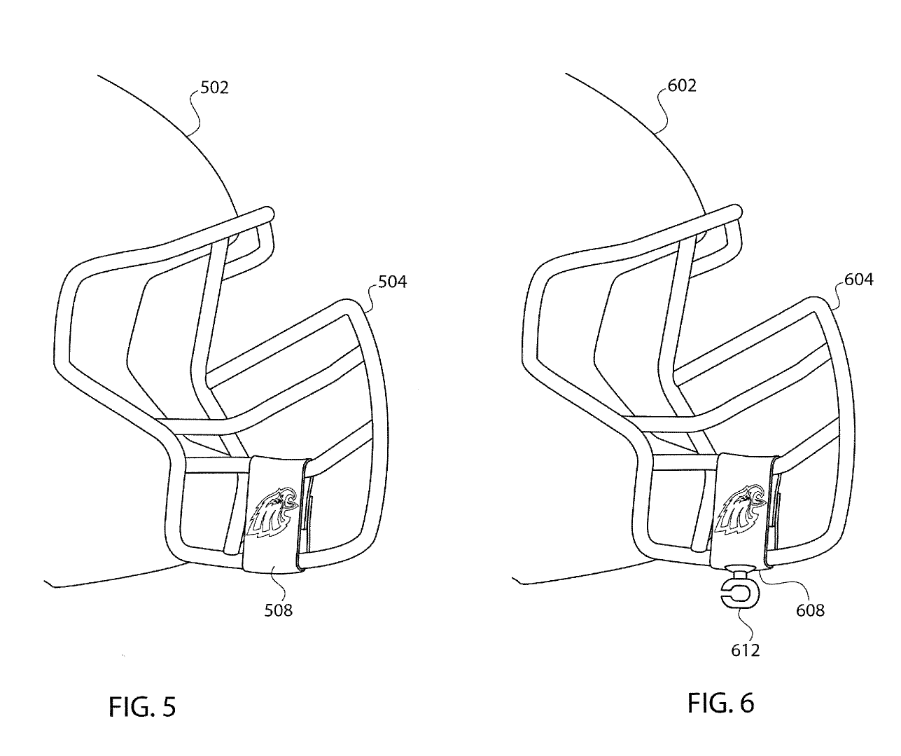

Referring now to FIG. 4, a diagram showing a system for advertising on a helmet using a strap with one or more magnetic fasteners is illustratively depicted in accordance with one embodiment of the present principles. In an illustrative embodiment, a strap 408 including advertisements, logos, etc. 410 may include one or more fabric hook and loop fasteners 412 in accordance with the present principles. The fasteners 412 may be employed to secure the strap around a portion of a helmet (not shown) such that the advertisements, names, logos, etc. 410 are visible on the substantially flat outward-facing surface of the strap 408.

It is noted that although a printed graphic is displayed on the strap 108, 208, 308, 408 in FIGS. 1-4, it is contemplated that an LED screen, video screen, other display means, or a music/video playing device may also be employed according to the present principles. In embodiments which include an LED screen, video screen, other display means, or a music/video playing device which require power for the display or music/video playing device to function, the display may be powered by a battery inside the screen, a battery pack attached to the screen, solar power, or any other means known in the art which may be employed to power a device including a screen. In embodiments which include a music/video playing device, the device may be integrated into the strap, may be inserted into a pocket on the strap, or attached in any manner known in the art to the strap.

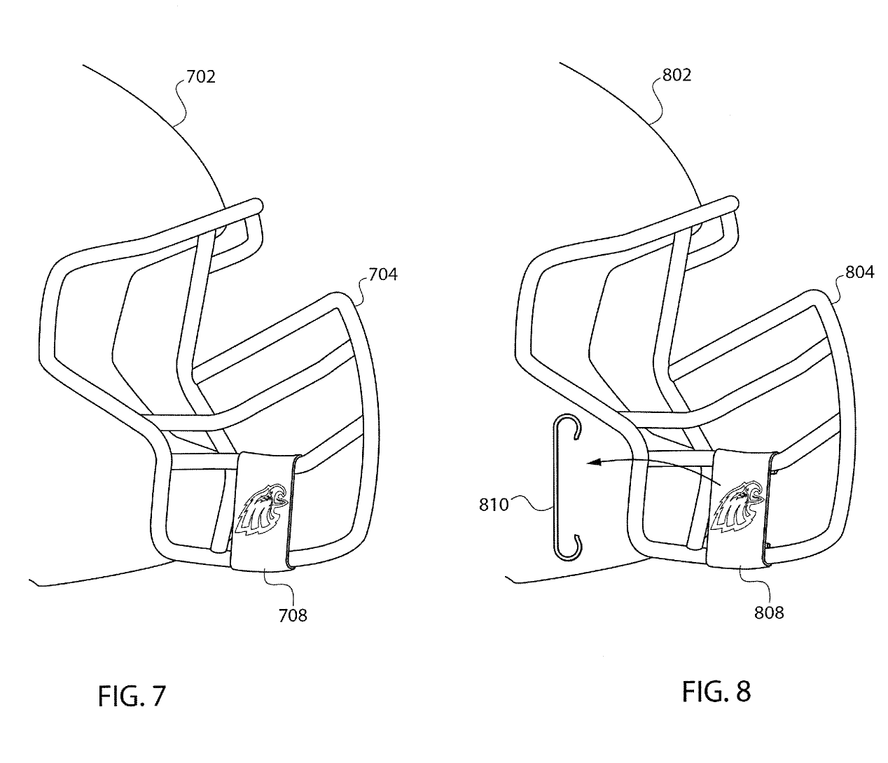

Referring now to FIG. 5, a diagram showing a system for advertising on a helmet using a strap is illustratively depicted in accordance with one embodiment of the present principles. In one embodiment, a sports helmet (e.g., Lacrosse, Football, Hockey, etc.) includes a shell 502 and a facemask 504. A strap 508 including advertisements, names, logos, etc. may be attached to the facemask 504 by wrapping the strap 508 around two or more bars on the facemask 504 such that a substantially flat surface including the advertisements, names, logos, etc. on the strap 508 faces outwardly such that the advertisements, names, logos, etc. are visible on the substantially flat surface of the strap 508.

Referring now to FIG. 6, a diagram showing a system for advertising on a helmet using a strap is illustratively depicted in accordance with one embodiment of the present principles. In one embodiment, a sports helmet (e.g., Lacrosse, Football, Hockey, etc.) includes a shell 602 and a facemask 604. A strap 608 including advertisements, names, logos, etc. may be attached to the facemask 604 by wrapping the strap 608 around two or more bars on the facemask 604 such that a substantially flat surface including the advertisements, names, logos, etc. on the strap 608 faces outwardly such that the advertisements, names, logos, etc. are visible on the substantially flat surface of the strap 608.

In one embodiment according to the present principles, a mouth guard holder 612 may be included as either a removable or a permanent element of the strap 608. In embodiments where the mouth guard holder 612 is removable from the strap 608, the mouth guard holder 612 may be attached by any means for temporary attachment of objects known in the art (e.g., snaps, buttons, hook and loop fasteners, magnets, etc.).

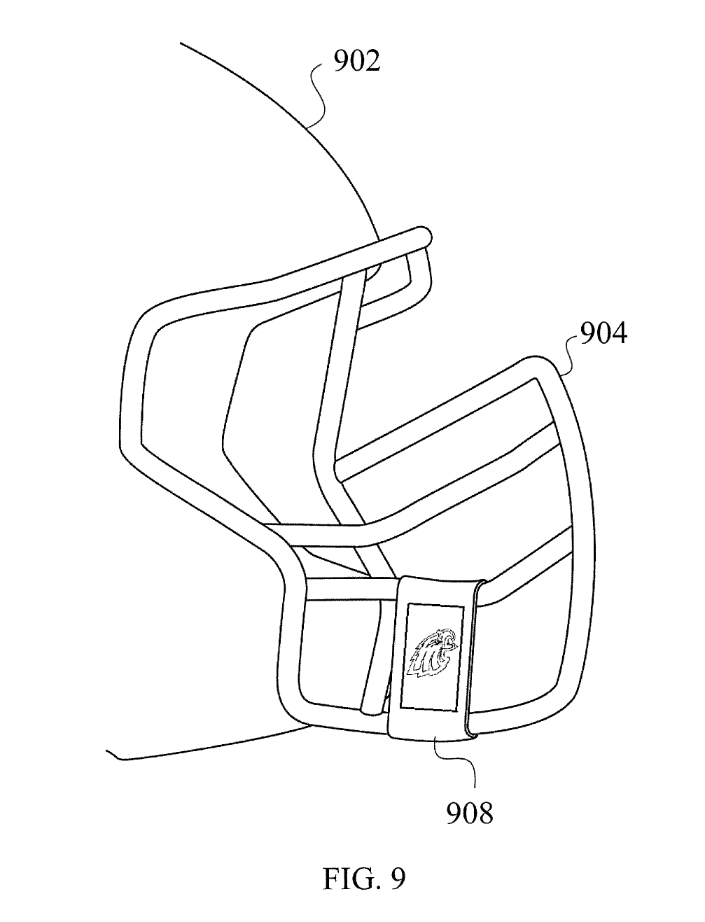

Referring now to FIG. 7, a system for advertising on a helmet using a sticker-type device is illustratively depicted in accordance with one embodiment of the present principles. In one embodiment, a sports helmet (e.g., Lacrosse, Football, Hockey, etc.) includes a shell 702 and a facemask 704. A sticker-type device 708 including advertisements, names, logos, etc. may be attached to the facemask 704 by attaching the sticker-type device 708 to two or more bars on the facemask 704 or a chin guard (not shown) such that a substantially flat surface including the advertisements, names, logos, etc. on the sticker-type device 708 faces outwardly such that the advertisements, names, logos, etc. are visible on the substantially flat surface of the sticker-type device 708.

The sticker-type device 708 may be attached by sticking opposing ends of the sticker-type device to each other, or may be attached directly to the helmet facemask 704 or chin guard (not shown). It is noted that the entire back of the sticker-type device 708 may be peel-and-stick, water-dip, etc., may be made of any suitable material (e.g., paper, vinyl, silicone, etc.), and may include a mouth guard holder in some embodiments according to the present principles.

Referring now to FIG. 8, a diagram showing a system for advertising on a helmet using a semi-rigid clip is illustratively depicted in accordance with one embodiment of the present principles. In one embodiment, a sports helmet (e.g., Lacrosse, Football, Hockey, etc.) includes a shell 802 and a facemask 804. A semi-rigid clip 808 including advertisements, names, logos, etc. may be attached to the facemask 804 by clipping the semi-rigid clip 808 around two or more bars on the facemask 804 such that a substantially flat surface including the advertisements, names, logos, etc. on the semi-rigid clip 808 faces outwardly such that the advertisements, names, logos, etc. are visible on the substantially flat surface of the semi-rigid clip 808. A side view of the semi-rigid clip 810 is illustratively depicted according to the present principles.

It is noted that the semi-rigid clip may be made of any suitable material (e.g., plastic, vinyl, silicone, etc.), may be substantially rigid, may be completely rigid, may include a hinge for easy attachment, and may include a mouth guard holder in some embodiments according to the present principles.

Having described preferred embodiments of a system and method for reducing latency time with cloud services (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

1. A system for displaying one or more graphics on a sports helmet, comprising:
a strap material of a length which is sufficient to wrap completely around a selected portion of a helmet, wherein the strap material is flexible and substantially planar;
one or more fasteners included on opposing ends of the strap material, wherein a loop with one or more substantially flat surfaces is formed by connecting the one or more fasteners to the one or more fasteners attached to the opposing end of the strap material; and
a section of the one or more substantially flat surfaces of the strap material displaying the one or more graphics, wherein the one or more graphics are positioned outwardly such that the one or more graphics are visible when the strap material is wrapped around the selected portion of the helmet.

2. The system as recited in claim 1, wherein the strap material includes a clip configured to hold a mouth guard.

3. The system as recited in claim 1, wherein the one or more graphics are printed graphics.

4. The system as recited in claim 1, wherein the one or more graphics are displayed using a Light Emitting Diode (LED) stroller screen.

5. The system as recited in claim 1, wherein the one or more graphics are displayed using a video screen.

6. The system as recited in claim 1, wherein the strap material is configured to wrap completely around a chin guard of a helmet.

7. The system as recited in claim 1, wherein the strap material is configured to wrap completely around two or more bars on a facemask of a helmet.

8. The system as recited in claim 1, wherein the strap material is a semi-rigid clip configured to attach to a helmet chin guard, or two or more bars on a facemask.

9. The system as recited in claim 1, wherein the strap material is a sticker-type device configured to attach to a helmet chin guard, or two or more bars on a facemask.

10. A method for displaying one or more graphics on a sports helmet, comprising:
wrapping a strap material of a length which is sufficient to wrap completely around a selected portion of a helmet completely around the selected portion of a helmet, wherein the strap material is flexible and substantially planar;
connecting one or more fasteners included on one end of the strap material to one or more fasteners included on the opposing end of the strap material, wherein a loop with one or more substantially flat surfaces is formed by the strap material; and
displaying the one or more graphics on the one or more substantially flat surfaces of the strap material, wherein the one or more graphics are positioned outwardly such that the one or more graphics are visible when the strap material is wrapped around the selected portion of the helmet.

11. The method as recited in claim 10, wherein the strap material includes a clip configured to hold a mouth guard.

12. The method as recited in claim 10, wherein the one or more graphics are printed graphics.

13. The method as recited in claim 10, wherein the one or more graphics are displayed using a Light Emitting Diode (LED) scroller screen.

14. The method as recited in claim 10, wherein the one or more graphics are displayed using a video screen.

15. The method as recited in claim 10, wherein the strap material is configured to wrap completely around a chin guard of a helmet.

16. The method as recited in claim 10, wherein the strap material is configured to wrap completely around two or more bars on a facemask of a helmet.

17. The method as recited in claim 10, wherein the strap material is a semi-rigid clip configured to attach to a helmet chin guard, or two or more bars on a facemask.

18. The method as recited in claim 10, wherein the strap material is a sticker-type device configured to attach to a helmet chin guard, or two or more bars on a facemask.
